(19) United States
(12) Patent Application Publication
(10) Pub. No.: US 2011/0016028 A1
(43) Pub. Date: Jan. 20, 2011

(54) METHOD FOR BILLING SERVICES SUCH AS PUSH MAIL

(76) Inventors: Famory Toure, Nozay (FR); Thomas Bourgeois, Clamart (FR); Hélène Papini, Nozay (FR); Francois Reynes, Orvault (FR); Marc Leprince, Orvault (FR); William Huguet, Nozay (FR); Gilles Ganne, Orvault (FR)

Correspondence Address: FAY SHARPE/LUCENT, 1228 Euclid Avenue, 5th Floor, The Halle Building, Cleveland, OH, 44115-1843, US

(21) Appl. No.: 12/598,584

(22) PCT Filed: May 2, 2008
(86) PCT No.: PCT/IB2008/001101

§ 371 Date: Sep. 24, 2010

(30) Foreign Application Priority Data
May 4, 2007 (EP) 07290568.0
May 4, 2007 (FR) 0703268

(51) Int. Cl. G06Q 30/00

(52) U.S. Cl. 705/30; 705/1.1

(57) ABSTRACT

A method enabling a mobile communication terminal belonging to an operator's network to access a service such as push mail, which method comprises a step of creating a first permanent private connection between a platform and the operator's network, which platform comprises a database of the users of pre-payment services and a dynamic IP address-assigning server, which method further comprises:
a step of receiving a request from the mobile communication terminal,
a step of identifying that terminal and the service requested by it,
a step of querying the user database in order to determine whether the identified terminal enjoys prepayment for the requested service,
a step of charging the credit of the terminal's user for the requested prepaid service.

The invention pertains to telecommunications.

Users of certain mobile communication terminals have enjoyed “push mail” e-mail service for several years. The service makes it possible to receive, along with the subject of the e-mail, the first few lines of the message's text.

“Push mail” services are billed after the fact.

An anonymous prepaid Internet access method is disclosed in the document FR2817056. This method makes it possible to make purchases over the Internet or view pay websites by debiting prepaid connection time corresponding to the amount of the purchase or viewing of the pay site. The method described in the document FR2817056 has the drawback of requiring that software be installed on the computer beforehand.

The document WO 2007/001231 describes a 3GPP network comprising a AAA server making it possible to check, in real time, the credit remaining for accessing a prepaid service.

The invention is intended to provide an efficient method for billing services such as push mail, with this method not requiring any modification to communication terminals and being user-friendly.

The invention is particularly intended to provide a method of the above type for so-called “Greenfield” operators which do not have all of the proprietary infrastructure needed to route messages.

For these purposes, the invention, in a first aspect, pertains to a method enabling a mobile communication terminal belonging to an operator's network to access a service such as push mail, which method comprises a step of creating a first permanent private connection between a platform and the operator's network and a step of creating a second permanent private connection between the platform and an network operator center, said platform comprising a database of the users of pre-payment services, which method further comprises:
a step of receiving a request from the mobile communication terminal,
a step of identifying that terminal and the service requested by it,
a step of querying the user database in order to determine whether the identified terminal enjoys prepayment for the requested service,
a step of counting down the credit of the terminal's user for the requested prepaid service.

The invention, in a second aspect, pertains to a method enabling a mobile communication terminal belonging to an operator's network to access a service such as push mail, which method comprises a step of creating a first permanent private connection between a platform and the operator's network, said platform comprising a database of the users of pre-payment services and a dynamic IP address-assigning server, which method further comprises:
a step of receiving a request from the mobile communication terminal,
a step of identifying that terminal and the service requested by it,
a step of querying the user database in order to determine whether the identified terminal enjoys prepayment for the requested service,
a step of counting down the credit of the terminal's user for the requested prepaid service.

The method advantageously comprises a countdown of the user's credit to a minimum predetermined threshold value, with a message being sent to the user terminal once this threshold value has been reached, said message informing the user that the threshold value has been reached and suggesting that the account be topped up.

Advantageously, the dynamic IP address-assigning server is an authentication, authorization, and accounting server.

Advantageously, the dynamic IP address-assigning server implements the DHCP and RADIUS protocols.

In one embodiment, the method comprises a step of creating a second permanent private connection between the platform and the network operator center.

Other objects and advantages of the invention will become apparent upon reading the description below, with reference to the attached drawings, in which:

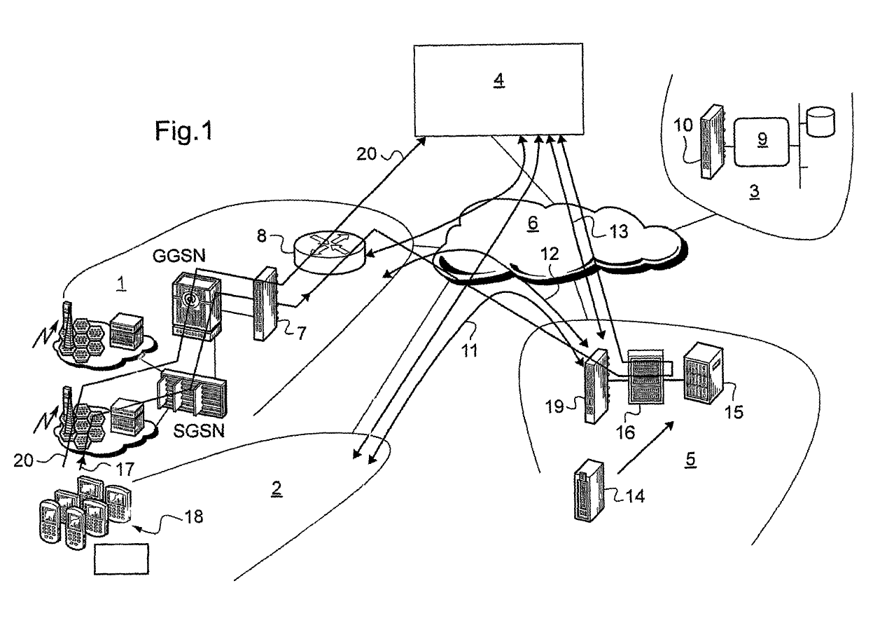

FIG. 1 is a diagram depicting a first embodiment of the invention;

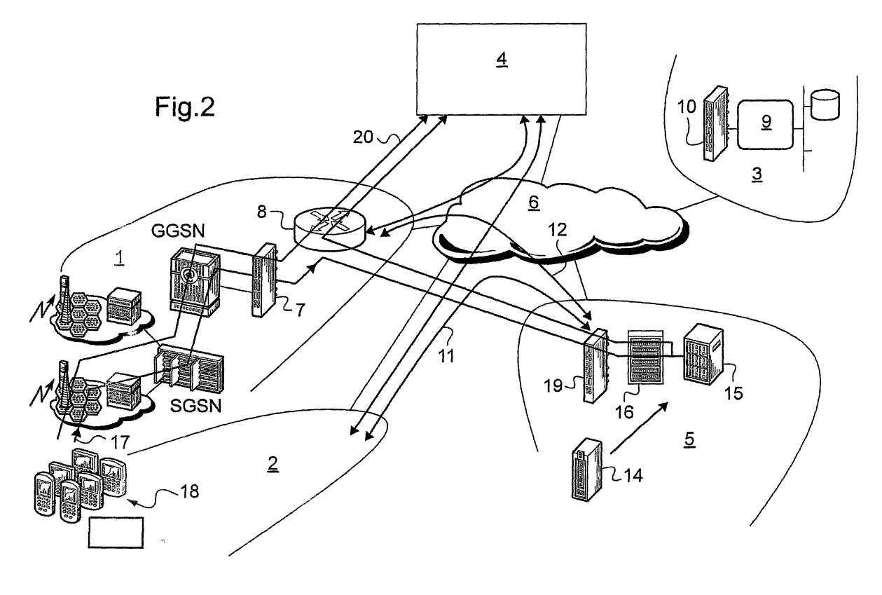

FIG. 2 is a diagram depicting a second embodiment of the invention;

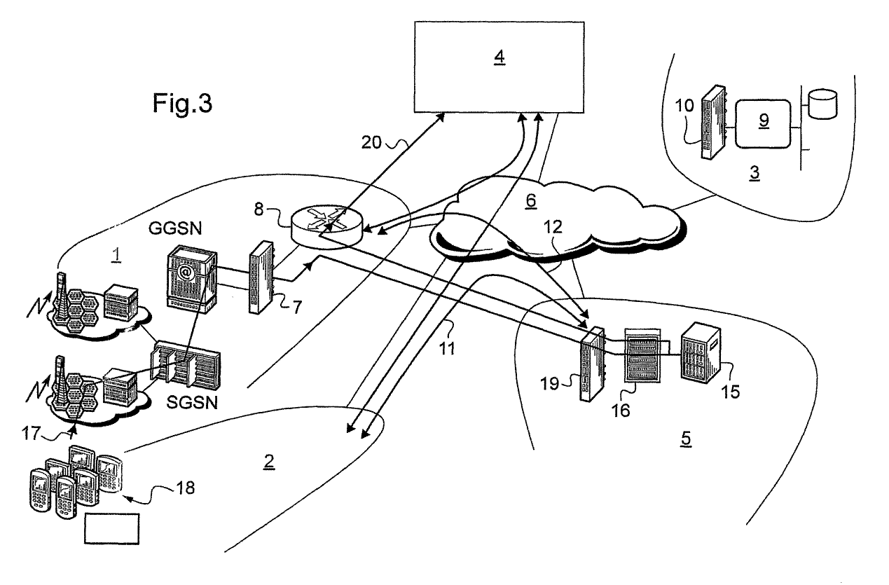

FIG. 3 is a diagram depicting a third embodiment of the invention;

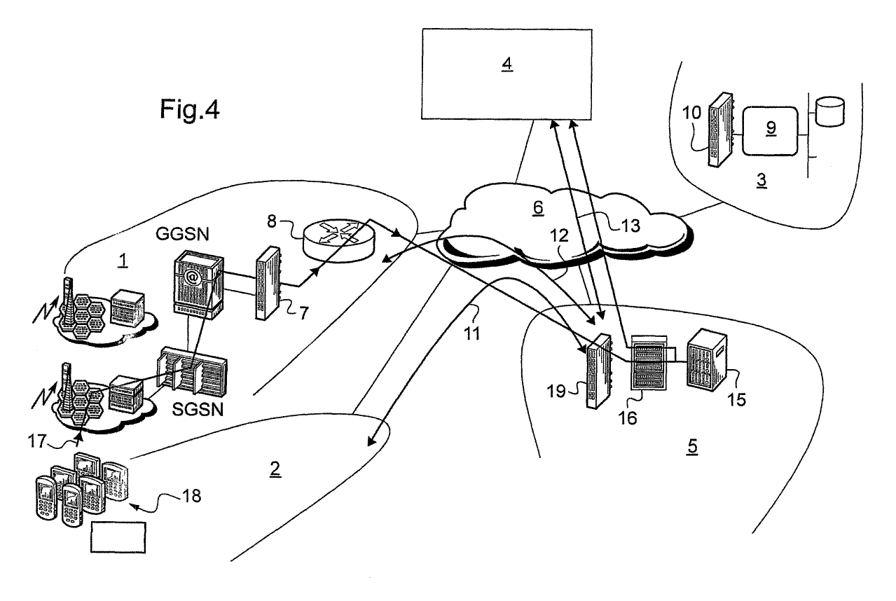

FIG. 4 is a diagram depicting a fourth embodiment of the invention;

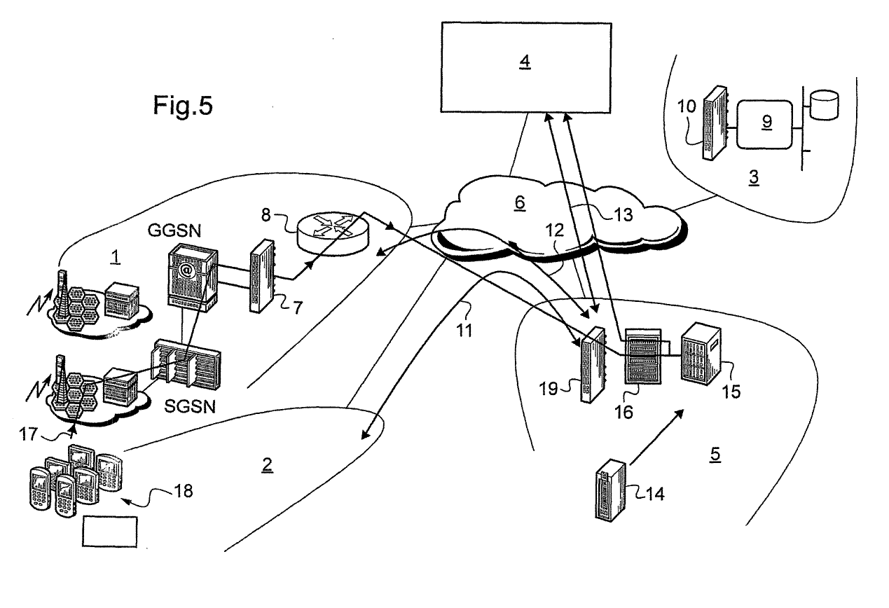

FIG. 5 is a diagram depicting a fifth embodiment of the invention.

FIG. 1 is described first.

FIG. 1 depicts two network operators 1, 2, a private enterprise network 3, a network operator center 4, and a platform 5. Each of the networks 1-3, the center 4, and the platform 5 are connected to the Internet 6.

Only the structure of one of the network operators is depicted in greater detail, for simplicity's sake. As an example, this network 1 may be a GPRS (General Packet Radio Service) network and, in a manner known per se, comprises an SGSN (Serving GPRS Support Node) router and a GGSN (Gateway GPRS Support Node) gateway. A firewall 7 is placed between the CGSN gateway and a virtual private network hub 8.

The enterprise network, in a manner known per se, further comprises a server 9 and a firewall 10.

The platform 5 is connected to each operator network 1, 2, by a tunnel 11, 12. Here, “tunnel” refers to a virtual peer-to-peer connection enabling the creation of a virtual private network VPN. A packet operating using a tunneling protocol is encapsulated in order to be placed in an IP packet, with this packet then being transmitted using the TCP/IP protocol. The platform 5 is further connected to the network operator center 4 by a tunnel 13.

The platform 5 comprises a dynamic IP address-assigning server 14. In one embodiment, this server 14 is an authentication, authorization, and accounting server AAA. Advantageously, the dynamic IP address-assigning server implements the DHCP and RADIUS protocols.

A database 15 contains information regarding the subscribers of prepaid services such as push mail. Access to this database 15 may, for example, be obtained using JDBC (Java DataBase Connectivity) technology, with this programming interface making it possible to connect to any database using the same syntax. A public key infrastructure makes it possible to provide optimal security for data exchanged through the VPN tunnels 11-13.

The prepaid service data flow is represented by the arrow 17 in FIG. 1. This flow, exiting the mobile communication terminals 18, moves from the network 1 to the platform 5 via the VPN tunnel 12. The public key infrastructure strengthens the protection of encrypted data traveling within the VPN tunnel 12. This security is further strengthened by a firewall 19 at the input/output of the platform 5.

The data flow runs from the platform 5 to the network operator center 4 via the tunnel 13.

The service data flows exiting the platform are metered by a device known as a charging proxy 16. Once this flow has reached a predetermined value, a message is sent to the communication terminal 18, suggesting that the account be topped up.

Non-prepaid service data is routed at the source, so that this data does not clog the platform 5.

Now, FIG. 2 is described. In FIG. 2, the elements which are analogous to those described for the embodiment in FIG. 1 have the same reference numbers.

In the variant embodiment depicted in FIG. 2, the flow of data exiting the platform 5 does not directly reach the network operator center 4 via a dedicated VPN tunnel, but rather returns to the operator network 1 via the first tunnel 12. The hub 8 routes this flow to the network operator center 4.

As in the embodiment of FIG. 1, the flow 20 of non-prepaid service data does not pass through the platform 5.

Now, FIG. 3 is described. In FIG. 3, the elements which are analogous to those described for the embodiment in FIG. 1 have the same reference numbers.

In this embodiment, the platform 5 does not comprise a dynamic IP address-assigning server 14. The flow of service data (whether prepaid or not) passes through the platform 5.

Now, FIGS. 4 and 5 are described.

In FIGS. 4 and 5, the elements which are analogous to those described for the embodiment in FIG. 1 have the same reference numbers.

In these embodiments, the packets are transmitted through the tunnels 11, 12 by means of the UDP protocol.

The VPN tunnels 11, and 12, and 13 for sharing the data may be created in the form of a public key infrastructure or a so-called leased line.

A public key infrastructure makes it possible to provide optimal security for data exchanged through the VPN tunnels 11-13.

A leased line makes it possible to provide greater safety, because this line is allocated only to exchange data between the operators network's 1, 2 and the private network 3.

In a leased line, the data, in addition to the aforementioned components, travels through a router located at the entrance of the VPN tunnels in the platform 5.

The data flow runs from the platform 5 to the network operator center 4 via the tunnel 13.

The service data flows exiting the platform are metered by a data metering device 16 known as a charging proxy. Once this flow has reached a predetermined value, a message is sent to the communication terminal 18, suggesting that the account be topped up. Then, if the account is not topped up, the data flow metering device 16 blocks the data's traffic.

Non-prepaid service data is routed at the source, so that this data does not clog the platform 5.

The inventive method is suitable for any type of push service based on IP protocol, and the platform can also assign an IP address using DHCP or Radius, identify the user, and perform prepaid billing, even if the data channel has been open for a long time.

The dynamic assigning of IP addresses by the platform makes it possible to assign specific addresses to postpaid users and therefore to not route their traffic over the prepaid platform.

The method makes it possible to offer push services to prepaid users with a minimal investment by the operator, as the platform may be hosted and shared.

1. A method enabling a mobile communication terminal belonging to an operator's network to access a service such as push mail, which method comprises a step of creating a first permanent private connection between a platform and the operator's network and a step of creating a second permanent private connection between the platform and a network operator center, said platform comprising a database of the users of pre-payment services, which method further comprises:
a step of receiving a request from the mobile communication terminal,
a step of identifying that terminal and the service requested by it,
a step of querying the user database in order to determine whether the identified terminal enjoys prepayment for the requested service,
a step of charging the credit of the terminal's user for the requested prepaid service.

2. A method enabling a mobile communication terminal belonging to an operator's network to access a service such as push mail, which method comprises a step of creating a first permanent private connection between a platform and the operator's network, which platform comprises a database of the users of pre-payment services and a dynamic IP address-assigning server, which method further comprises:
a step of receiving a request from the mobile communication terminal,
a step of identifying that terminal and the service requested by it,
a step of querying the user database in order to determine whether the identified terminal enjoys prepayment for the requested service,
a step of counting down the credit of the terminal's user for the requested prepaid service.

3. A method according to claim 1, wherein the user's credit is counted down to a minimum predetermined threshold value, with a message being sent to the user terminal once this threshold value has been reached, said message informing the user that the threshold value has been reached and suggesting that the account be topped up.

4. A method according to claim 2, wherein the dynamic IP address-assigning server is an authentication, authorization, and accounting server.

5. A method according to claim 4, wherein the dynamic IP address-assigning server implements the DHCP and RADIUS protocols.

6. A method according to claim 1, wherein it comprises a step of creating a second permanent private connection between the platform and the network operator center.

7. A method according to claim 2, wherein it comprises a step of creating a second permanent private connection between the platform and the network operator center.
